(19) United States
(12) Patent Application Publication
(10) Pub. No.: US 2010/0263210 A1
(43) Pub. Date: Oct. 21, 2010

(54) WATER HEATER HAVING TEMPERATURE CONTROL SYSTEM WITH THERMOSTATICALLY CONTROLLED MIXING DEVICE

(75) Inventors: Michael W. Gordon, Grand Rapids, MI (US); Daniel Beabout, Kentwood, MI (US); Taylor Alberts, Middleville, MI (US); Christopher Stafford, Hastings, MI (US); Wade Bernreuter, Lowell, MI (US)

Correspondence Address: RATNERPRESTIA, P.O. BOX 980, VALLEY FORGE, PA, 19482, US

(73) Assignee: Bradford White Corporation, Ambler, PA (US)

(21) Appl. No.: 12/823,575

(22) Filed: Jun. 25, 2010

Related U.S. Application Data
(62) Division of application No. 11/904,107, filed on Sep. 26, 2007.

(51) Int. Cl. B23P 17/00; B23P 11/00

(52) U.S. Cl. 29/890.09; 29/428

(57) ABSTRACT

A method of improving hot water supply performance of a water heater is provided. The method includes coupling an outlet port of a water tempering device to the cold water inlet port of a water heater for delivering cold water from the cold water supply line into the water storage tank. The inlet port of the tempering device is coupled to the hot water outlet port of the water heater for receiving hot water from the water storage tank to the hot water supply line. A conduit of the tempering device is positioned between the inlet and outlet ports of the tempering device for diverting a portion of the cold water delivered from the cold water supply line into the conduit. The tempering device mixes the diverted cold water with the hot water received from the water storage tank, and delivers the mixed water into the hot water supply line.

### CROSS REFERENCE TO RELATED APPLICATIONS

This application is a Divisional patent application of U.S. patent application Ser. No. 11/904,107, filed Sep. 26, 2007, the content of such application being incorporated by reference herein.

### FIELD OF THE INVENTION

The present invention relates to a method of improving hot water supply performance of a water heater.

### BACKGROUND OF THE INVENTION

There is a need to improve the thermal performance of conventional water heaters. Thermal efficiency improvements facilitate water and energy conservation and represent cost savings to the end user.

First-Hour Rating is an industry-wide measure of the performance of a water heater. It is a measure of the volume of hot water (at a pre-determined temperature) that a water heater can supply in a one-hour time period. Water heater manufacturers continually strive to increase performance, whether quantified in terms of First-Hour Rating or other measures. Accordingly, there remains a continuing need to improve the thermal performance of a water heater.

### SUMMARY OF THE INVENTION

According to an exemplary embodiment of the invention a method of improving hot water supply performance of a water heater is provided. The method comprises the step of coupling an outlet port of a water tempering device to the cold water inlet port of a water heater for delivering cold water from the cold water supply line into the water storage tank. The inlet port of the water tempering device is coupled to the hot water outlet port of the water heater for receiving hot water from the water storage tank to the hot water supply line. A conduit of the water tempering device is positioned between the inlet port and the outlet port of the water tempering device for diverting a portion of the cold water delivered from the cold water supply line into the conduit. The water tempering device is configured to selectively mix the diverted cold water with the hot water received from the water storage tank, and deliver the mixed water into the hot water supply line.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity. Included in the drawings are the following figures:

FIG. 1A is a perspective view of an embodiment of a water heater installation including a water heater and a water tempering device releasably mounted between the water heater and hot and cold water supply lines according to aspects of this invention;

FIG. 1B is a perspective view of the water heater of FIG. 1A;

FIGS. 2A and 2B depict top plan and front elevation views, respectively, of an embodiment of a water tempering device according to aspects of this invention;

FIGS. 3A and 3B depict front elevation and end views, respectively, of the flexible conduit assembly of FIGS. 2A and 2B according to aspects of this invention, wherein the flared fittings are illustrated in phantom lines;

FIGS. 4A-4C depict right elevation, rear elevation and top plan views, respectively, of the fitting of FIGS. 2A and 2B according to aspects of this invention;

FIGS. 5A-5C depict front elevation, left elevation and top plan views, respectively, of the mixing device of FIGS. 2A and 2B according to aspects of this invention;

FIG. 5D depicts a partial exploded perspective view of the mixing device of FIGS. 2A and 2B illustrating the locking ring and the adjusting knob, according to aspects of this invention;

FIG. 5E depicts a cross-sectional view of the locking ring and the adjusting knob taken along the lines 5E-5E of FIG. 5C, wherein the knob is positioned in a locked configuration according to aspects of this invention;

FIG. 5F depicts a detailed view of the locking ring and the knob illustrated in FIG. 5E;

FIG. 5G depicts another cross-sectional view of the locking ring and the adjusting knob taken along the lines 5E-5E of FIG. 5C, wherein the knob is positioned in an adjustable configuration according to aspects of this invention;

FIG. 5H depicts a detailed view of the locking ring and the knob illustrated in FIG. 5G;

FIGS. 6A-6C depict front elevation, bottom plan and top plan views, respectively, of the locking ring of FIG. 5D according to aspects of this invention; and

FIG. 7 depicts a top perspective schematic view of a kit including the water tempering device shown in FIGS. 2A and 2B positioned within a packaging box according to aspects of this invention.

### DETAILED DESCRIPTION OF THE INVENTION

Although the invention is illustrated and described herein with reference to specific embodiments, the invention is not intended to be limited to the details shown. Rather, various modifications may be made to the illustrated embodiments within the scope and range of equivalents of the claims and without departing from the invention. Also, the embodiments selected for illustration in the figures are not shown to scale and are not limited to the proportions shown.

Referring generally to the figures and according to one exemplary embodiment of the invention, a method of improving hot water supply performance of a water heater 10 is provided. The water heater has a water storage tank 18, a cold water inlet port 20 for receiving cold water from a cold water supply line, and a hot water outlet port 22 for delivering hot water to a hot water supply line. The method includes the step of coupling an outlet port 30 of a water tempering device 16 to the cold water inlet port 20 of the water heater 10 for delivering cold water from the cold water supply line 12 into the water storage tank 18. An inlet port 32 of the water tempering device 16 is coupled to the hot water outlet port 22 of the water heater 10 for receiving hot water from the water storage tank 18 to the hot water supply line 14. A conduit 28 of the water tempering device 16 is positioned between the inlet port 32 and the outlet port 30 of the water tempering device 16 for diverting a portion of the cold water delivered from the cold water supply line 12 into the conduit 28. The water tempering device 16 is configured to selectively mix the diverted cold water with the hot water received from the water storage tank 18, and deliver the mixed water into the hot water supply line 14.

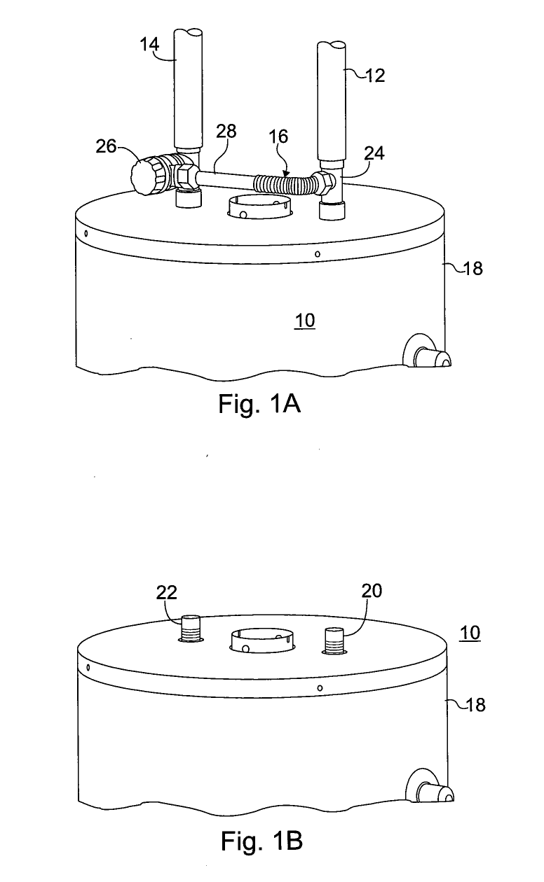

Referring specifically to FIGS. 1A and 1B, a perspective view of a water heater installation is shown in FIG. 1A and the water heater 10 is illustrated by itself in FIG. 1B. In the installation shown in FIG. 1A, a water heater 10 is attached to cold and hot water supply lines 12 and 14 via a water tempering device 16. The cold water supply line 12 delivers cold water from a water source into the water heater 10, and the hot water supply line 14 delivers hot water from the water heater 10 to one or more hot water distribution devices (not shown), such as a shower, a sink, a clothes washer, or a dishwasher.

The water heater 10 includes a water storage tank 18 for containing water (or any other fluid or liquid), an inlet port 20 positioned on a top surface of the water storage tank 18 for receiving cold water from the cold water supply line 12, and an outlet port 22 that is also positioned on the top surface of the water storage tank 18 for delivering hot water from the water storage tank to the hot water supply line 14. Although not shown, the inlet port 20 and/or the outlet port 22 of the water heater 10 may be connected to a conduit extending into the interior of the water storage tank 18 for delivering water to/from the water storage tank 18.

A water tempering device 16 is releasably coupled to both the inlet port 20 and to the outlet port 22 of the water heater 10 for diverting a portion of the cold water from the cold water supply line 12 to the hot water supply line 14. The water tempering device 16 is configured to selectively mix the cold water with the hot water.

The water tempering device 16 is generally configured for use with any conventional residential or commercial water heater having a storage tank 18, a cold water inlet port 20 and a hot water outlet port 22 positioned on the top surface of the water heater each having standard national pipe threads (NPT) threads (such as ¾ inch male NPT), where the ports 20 and 22 are oriented in parallel and spaced apart a standard distance (such as 8 inches or 11 inches).

The water tempering device 16 may be assembled onto a water heater at the factory or at the water heater installation site. Moreover, the water tempering device 16 may be provided as a kit and packaged along with a new water heater. Alternatively, the device 16 may be provided as a kit and sold and distributed separately from the water heater. The device 16 may be used for retrofitting an existing water heater to improve the First-Hour Rating of the existing water heater. No special tools are required for installing the water tempering device 16 to a water heater (either new or pre-existing) and water supply lines.

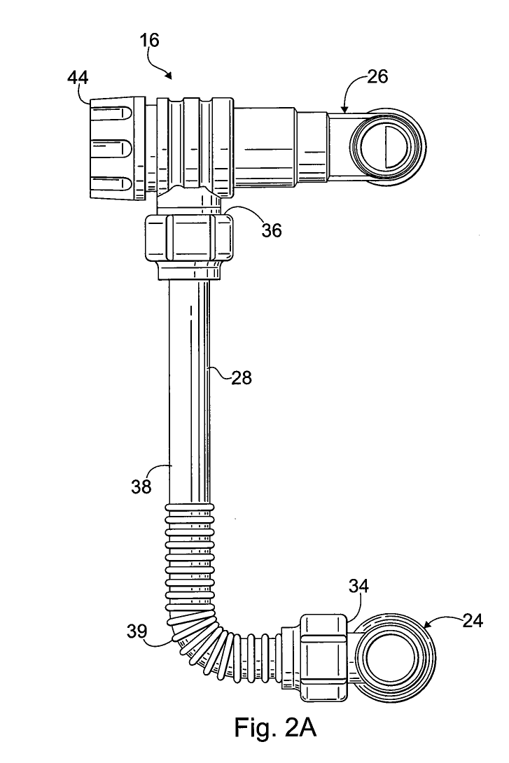

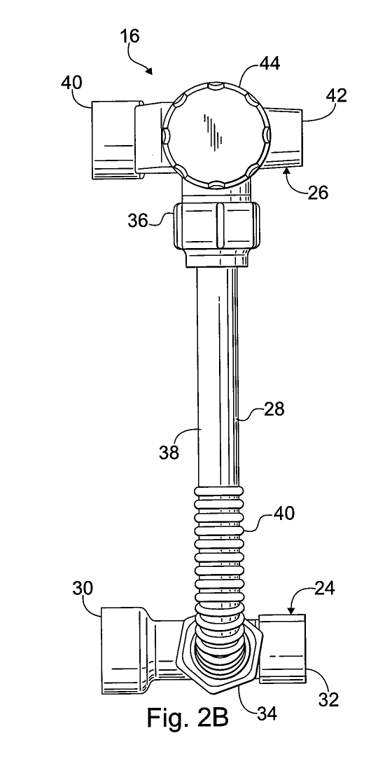

FIGS. 2A and 2B depict top plan and front elevation views, respectively, of an exemplary embodiment of the water tempering device 16 (referred to hereinafter as device 16) according to aspects of this invention. The water tempering device 16 generally includes a fitting 24, a mixing device 26 and a conduit assembly 28 coupled therebetween for delivering fluid from the fitting 24 to the mixing device 26.

The device 16 includes a fitting 24 that is threadedly connectable to the inlet port 20 of the water heater 10, a mixing device 26 that is threadedly connectable to the outlet port 20 of the water heater 10, and a flexible conduit assembly 28 releasably connected between the fitting 24 and the mixing device 26. The fitting 24 and the mixing device 26 may be releasably connected to the water heater 10 by couplings or threaded connections using standard tools, or another releasable connection style that does not require a welding or sweat soldering operation or pipe cutting.

The fitting 24 includes an inlet port 32 for coupling with the cold water supply line 12, an outlet port 30 for releasably coupling with the inlet port 20 of the water heater 10 to deliver cold water into the water storage tank, and a bypass port (not explicitly depicted in this view) for diverting a portion of the cold water from the cold water supply line 12 into the conduit assembly 28.

The conduit assembly 28 includes an inlet port 34 for coupling with the bypass port of the fitting 24, an outlet port 36 for coupling with the mixing device 26, and a hollow fluid flow passageway 38 defined between the inlet port 34 and the outlet port 36 for delivering the diverted cold water to the mixing device 26. The conduit assembly 28 includes a flexible portion 39 to permit bending of the conduit assembly 28 without compromising the structural integrity of the conduit assembly 28.

The mixing device 26 includes a mixing port (not explicitly depicted in this view) for coupling with the outlet port 36 of the conduit assembly 28, an inlet port 40 for releasably coupling with the outlet port 22 of the water heater 10, and an outlet port 42 for coupling with the hot water supply line 14. The hot water and cold water are combined and mixed together within the mixing device 26.

The flow of cold water from the conduit assembly 28 and the flow of hot water from the outlet port 22 of the water heater 10 into the mixing device 26 forces the hot water and cold water to mix within the mixing device 26 resulting in water at a lower temperature. The reduced temperature water is also referred to herein as tempered water. Combining the hot water with the cold water conserves the hot water contained within the tank, thereby increasing the First-Hour Rating of the water heater.

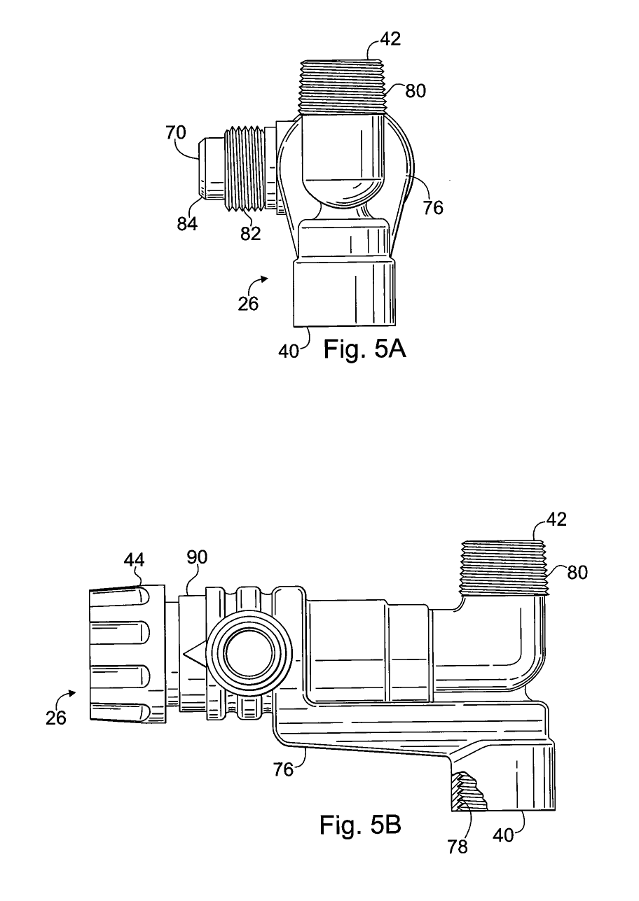

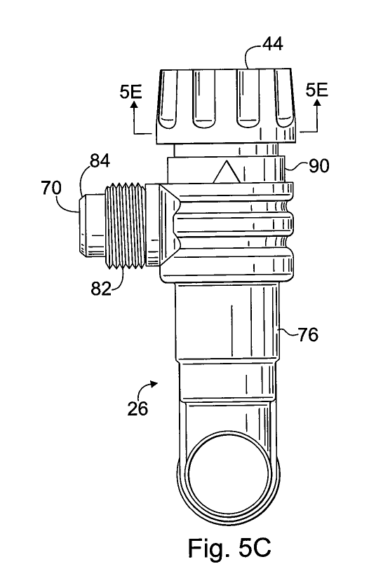

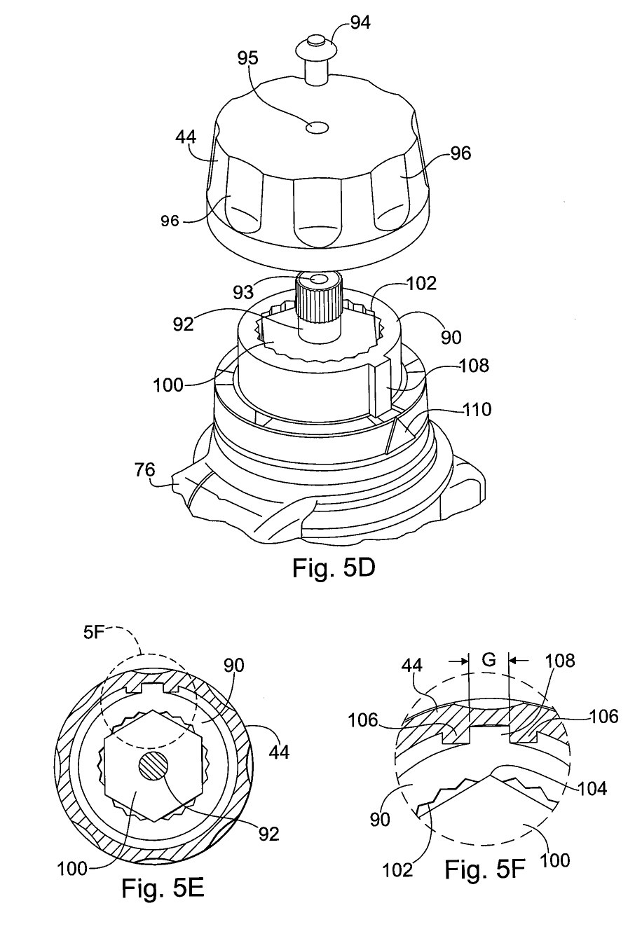

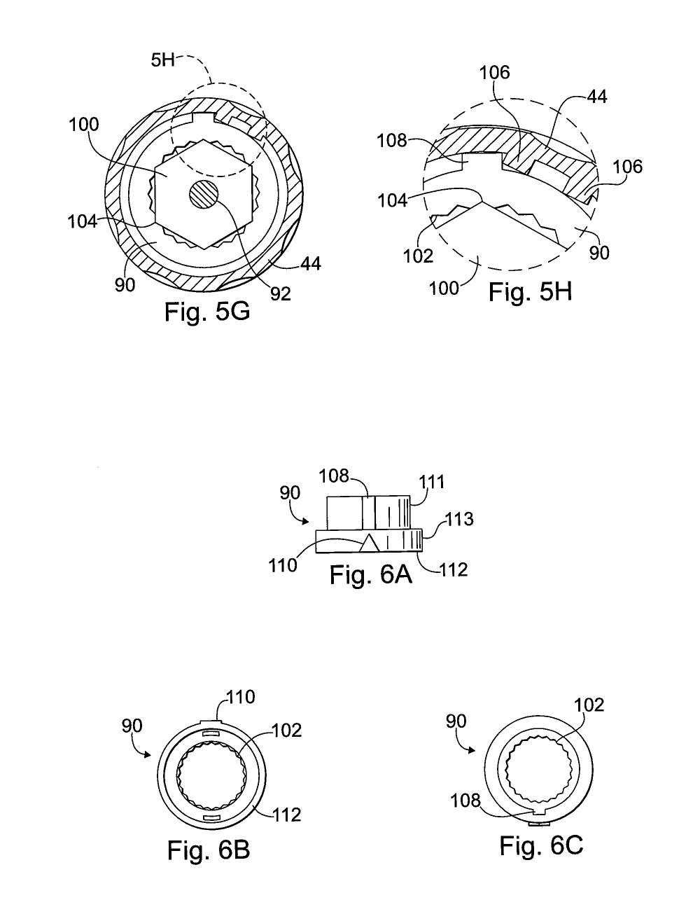

The temperature of the tempered water delivered into the hot water supply line 14 is maintained generally at a constant level. An adjustable knob 44 is provided on the water tempering device 16 for setting the tempered water temperature delivered through the outlet port 42 of the mixing device 26. The tempered water setting may be set by the installer of the water heater or the end user, as discussed in greater detail with reference to FIGS. 5D-5G.

The amount of cold water flowing into the mixing device 26 is dependent upon the temperature of the hot water delivered through the outlet port 22 of the water heater 22 and into the mixing device 26. More specifically, as the hot water temperature at outlet port 22 drops, the amount of cold water flowing into the mixing device 26 is reduced to compensate for the drop in temperature at the outlet port 22. Conversely, as the temperature of hot water at outlet port 22 rises, the amount of cold water flowing into the mixing device 26 is increased to compensate for the rise in temperature at the hot water outlet port 22. Although not shown, the mixing device 26 includes a thermostatically controlled valve (not shown) for controlling the volume of cold water flowing into the mixing device 26. Those skilled in the art will recognize that the mixing device 26 may include a variety of devices to control the flow of cold water and/or hot water therethrough.

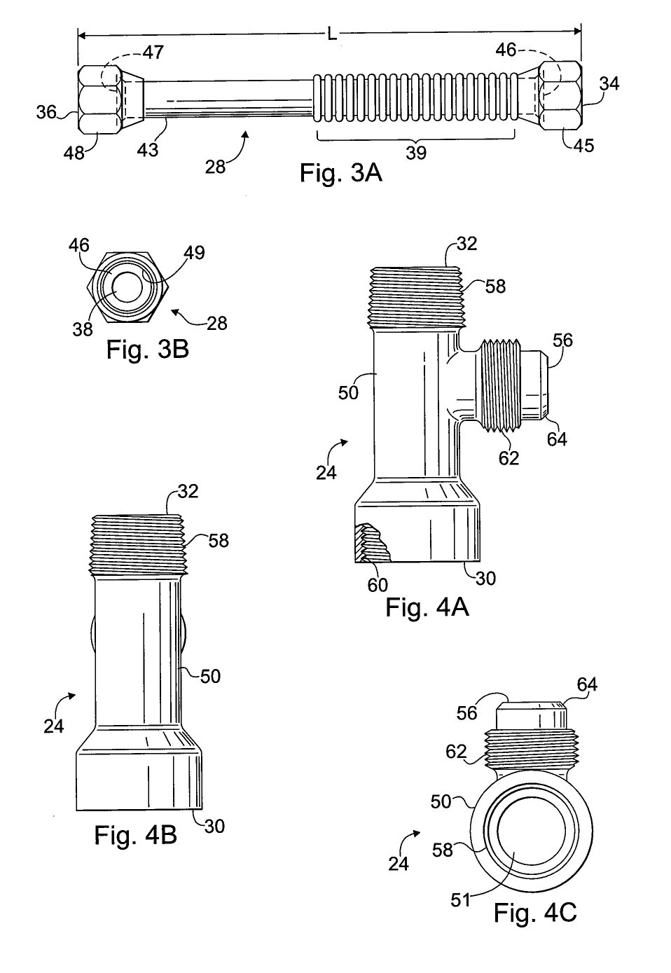

Referring now to the individual components of the water tempering device 26, FIGS. 3A and 3B depict front elevation and end views, respectively, of the flexible conduit assembly 28 according to aspects of this invention. The conduit assembly 28 generally includes an inlet port 34 for receiving cold water from the bypass port 56 of the fitting 24 (see FIG. 4A), and an outlet port 36 for delivering cold water into the mixing port 70 of the mixing device 26 (see FIG. 5A).

The flexible conduit assembly 28 includes a conduit 43 and two nuts 45 and 48 that are captively positioned on opposing sides of the conduit 43. The nuts 45 and 48 are included for captivating the conduit assembly 28 with the fitting 24 and the mixing device 26, respectively.

The conduit 43 is a hollow cylindrical tube or pipe defining a fluid flow passageway 38 therethrough. The fluid flow passageway 38 extends along the entire length “L” of the conduit assembly 28. Although not shown, the conduit 43 may optionally include a special coating or liner disposed within the fluid flow passageway 38. In the interest of reducing the number of components of the water-tempering device 16, and simplifying the assembly and installation of the water-tempering device 16, the conduit 43 shown in the figures does not include a liner positioned within the fluid flow passageway 38.

The conduit 43 includes a flexible portion 39 to permit bending of the conduit 43 without compromising the structural integrity of the conduit 43. The remaining portion of the conduit 43 is preferably rigid. The installer or end user may leverage the rigid portion of the conduit 43 to fasten the nuts 45 and 48 onto the fitting 24 and the mixing device 26, respectively. The conduit 43 is typically bent in the process of installing the conduit assembly 28 onto the mixing device 26, as described in greater detail later. The conduit 43 is shown in a bent configuration in FIGS. 1A, 2A and 2B. The flexible portion 39 may be formed by corrugating a portion of the length “L” of the conduit 43, as shown in FIG. 3A. The minimum bend radius of the conduit 43 may be 1.25 inches, for example. Alternatively, although not shown, the entire length “L” of the conduit 43 may be corrugated for increased flexibility.

The conduit 43 includes flare fittings at each end thereof. Flare fittings are utilized to fluidly connect two metallic tubes while limiting fluid leakage at the interface between the tubes. It has been found that flare fittings generally offer a high degree of long term reliability. Several styles of flare fittings are commonly used in the industry, including the 45° Society of Automotive Engineers (SAE) style and the 37° Joint Industry Conference (JIC) style.

Each flare fitting comprises a flared portion 46 and 47 (shown in phantom lines) and a nut 45 and 48 floatingly captivated over the flared portion 46 and 47, respectively. Flared portion 46 corresponds with the inlet port 34 of the conduit assembly 28, and flared portion 47 corresponds with the outlet port 36 of the conduit assembly 28. Each flared portion 46 and 47 is sized to mate with a chamfered surface of the fitting 24 and the mixing device 26. A flare tool (not shown) may be employed to flare the end of the conduit outward at a predetermined angle (typically 45° or 37°).

The nuts 45 and 48 corresponding to the flared portion 46 and 47, respectively, include interior threads 49 for releasably mating with threaded regions of the fitting 24 and the mixing device 26. The thread classification of the interior threads 49 may be ⅞-14 UNF 2B, for example.

The captivated nuts 45 and 48 are unconstrained and free to float along a portion of the length “L” of the conduit 43, however, the corrugations 39 may prohibit the nuts 45 and 48 from floating along the entire length “L” of the conduit 43. The nuts 45 and 48 float over the conduit 43 so that the nuts 45 and 48 can gradually compress the flared portion 46 and 47 against the chamfered surfaces 64 and 84 of the fitting 24 and the mixing device 26, when the nuts 45 and 48 are threaded onto the fitting 24 and the mixing device 26, respectively.

The nuts 45 and 48 and flare fittings 46 are designed to mate with the fitting 24 and the mixing device 26, as described in greater detail with reference to FIGS. 4A-5C. Those skilled in the art will recognize that the conduit assembly 28 may be designed to mate with the fitting 24 and the mixing device 26 in a variety of ways, and is not limited to flare fittings.

By way of non-limiting example, the outer diameter of the conduit 43 may be about ⅝ inch, and the length “L” of the conduit assembly 28 may be about 9 inches to about 13 inches to accommodate water heater ports 20 and 22 (see FIG. 1B) that are separated by an industry standard 8 inches or 11 inches. The conduit 43 may optionally be formed from 29 gauge stainless steel type 304 or 306 having a reflective silver appearance. The conduit 43 material may also be annealed for improved bending characteristics. The nuts 45 and 48 optionally include a hex-shaped exterior for gripping by a wrench, or other common tool. The nuts 45 and 48 may be formed from chrome-plated brass, or any other appropriate material. Those skilled in the art will recognize that the components of the flexible conduit assembly 28 may be formed from a variety of different materials, without departing from the scope of the invention.

FIGS. 4A-4C depict right elevation, rear elevation and top plan views, respectively, of the fitting 24 according to aspects of this invention. The fitting 24 includes an inlet port 32 for coupling with a cold water supply line 12 (see FIG. 1A), an outlet port 30 for releasably coupling with the cold water inlet port 20 of the water storage tank 18 to deliver cold water into the water storage tank 18, and a bypass port 56 for diverting a portion of the cold water from the cold water supply line 12 into the conduit assembly 28 (not shown in FIGS. 4A-4C).

The fitting 24 generally includes a body 50 that is formed in the shape of the letter “T.” The body 50 includes a hollow interior 51 to permit unrestricted fluid flow between the ports 32, 30 and 56. The body 50 may optionally be formed from die-cast nickel plated brass, or any other appropriate material known to those skilled in the art.

A threaded region 58 extending from the inlet port 32 is sized for releasable mating with mechanical threads (not shown) of the cold water supply line 12. The industry standard thread classification for a water supply line is ¾ female national pipe thread (NPT). Accordingly, the classification of the threaded region 58 may be ¾ male national pipe thread (NPT) for mating with the cold water supply line 12.

A portion of the body 50 is cut-away to illustrate an interior threaded region 60 extending from the outlet port 30. The interior threaded region 60 is configured for releasable mating with mechanical threads of the inlet port 20 of the water heater 10. The industry standard thread classification of the inlet and outlet ports 20 and 22 of a water heater is ¾ male national pipe thread (NPT). Accordingly, the classification of the threaded region 60 may be ¾ female national pipe thread (NPT) for mating with the inlet port 20 of the water heater 10. Although not shown, the outlet port 30 may include a slidingly captivated female threaded nut (similar to nut 48), in lieu of threaded region 60, for releasably coupling with the cold water inlet port 20 of the water heater 10.

Another threaded region 62 that is proximal to the bypass port 56 is sized for releasable mating with the mechanical threads 49 of the nut 45 of the conduit assembly 28. As stated previously, the thread classification of the interior threads 49 of the nut 45 may be ⅞-14 UNF 2B, for example. Accordingly, the classification of the threaded region 62 of the fitting 24 may be ⅞-14 UNF, for example, for threadedly mating with the interior threads 49 of the nut 45. Those skilled in the art will recognize that the classification of the aforementioned threaded regions may vary from that shown and described.

A chamfered or otherwise configured portion 64 is defined on the bypass port 56 of the fitting 24. In assembly, the nut 45 is threaded onto the threaded region 62 of the fitting 24 until the flared portion 46 of the conduit 43 is positioned in sealing contact with the chamfered portion 64 of the fitting 24. Sealing contact between the flared portion 46 and chamfered portion 64 limits leakage of fluid at that interface. The angle of the chamfered portion 64 corresponds to the angle of the flared portion 46 of the conduit 43 (typically 45° or 37°).

FIGS. 5A-5C depict front elevation, left elevation and top plan views, respectively, of the mixing device 26 according to aspects of this invention. The mixing device 26 generally includes a mixing port 70 for coupling with the outlet port 36 of the conduit assembly 28, an inlet port 40 for releasably coupling with the hot water outlet port 22 of the water heater 10, and an outlet port 42 for coupling with the hot water supply line 14. The mixing port 70 receives cold water from the conduit assembly 28, the inlet port 40 receives hot water from the water storage tank 18 of the water heater 10, and the outlet port 42 delivers the tempered water to one or more hot water distribution points (e.g., faucet, dishwasher, and so forth).

The mixing device 26 generally includes a body 76 defining a hollow interior to permit fluid flow between the ports 70, 40 and 42. The body 50 may optionally be formed from die-cast nickel plated brass, or any other appropriate material known to those skilled in the art. A thermostatically controlled valve (not shown) is housed within the hollow interior to control the flow of fluid between the ports 42 and 70.

According to one exemplary embodiment, the thermostatically controlled valve is configured to measure the temperature of the tempered water delivered through outlet port 42, compare the tempered water temperature with the setting of the knob 44, and permit or prohibit the flow of cold water through mixing port 70 based upon the comparison. Alternatively, the thermostatically controlled valve may be configured to measure the temperature of the hot water delivered into the inlet port 40, compare the hot water temperature with the setting of the knob 40, and permit or prohibit the flow of cold water through mixing port 70. A suitable thermostatically controlled valve is offered by Cash Acme, a division of Reliance Worldwide Corporation, of Cullman, Ala., USA.

A portion of the body 76 is cut-away to illustrate an interior threaded region 78 extending from the inlet port 40. The threaded region 78 is sized for releasable mating with mechanical threads of the outlet port 22 of the water heater 10. As noted previously, the industry standard thread classification of the inlet and outlet ports 20 and 22 of a water heater is ¾ male national pipe thread (NPT). Accordingly, the classification of the threaded region 78 may be ¾ female national pipe thread (NPT) for mating with the outlet port 22 of the water heater 10.

Although not shown, the inlet port 40 may include a slidingly captivated female threaded nut (similar to nut 48), in lieu of threaded region 78, for releasably coupling the inlet port 40 to the hot water outlet port 22 of the water heater 10. Several benefits are achieved by incorporating slidingly captivated nuts with the inlet port 40 of the mixing device 26 and the outlet port 30 of the fitting 24. First, the entire water tempering device 16 may be provided as a single pre-assembled unit, as opposed to three or more separate components that must be assembled together at the installation site. It follows that the time required to assemble a pre-assembled water tempering device onto a water heater would be significantly lower than sequentially assembling separate components of the water tempering device 16 onto the water heater. Third, the flexible portion 39 of the conduit may be omitted, which may represent a cost reduction. Fourth, if the water heater has a blower unit positioned on the top surface of the water heater, the blower unit must be removed to accommodate rotation of the long body 76 of the mixing device 26 onto the hot water outlet port 22 of the water heater 10. By incorporating a slidingly captivated nut onto the inlet port 40 of the mixing device 26, it is not necessary to remove the blower unit of the water heater. The female threaded nut can be rotated onto the hot water outlet port 22 of the water heater 10 without rotating the body of the mixing device 26

A threaded region 80 extending from the outlet port 42 of the mixing device 26 is sized for releasable mating with mechanical threads (not shown) of the hot water supply line 14. As noted previously, the industry standard thread classification for a water supply line is ¾ female national pipe thread (NPT). Accordingly, the thread classification of the threaded region 80 may be ¾ male national pipe thread (NPT) for mating with the hot water supply line 14.

Another threaded region 82 that is proximal to the mixing port 70 is sized for releasable mating with the mechanical threads 49 of the nut 48 of the conduit assembly 28. As stated previously, the thread classification of the interior threads 49 of the nut 48 may be ⅞-14 UNF 2B, for example. Accordingly, the classification of the threaded region 82 of the mixing device 26 may be ⅞-14 UNF, for example, for threadedly mating with the interior threads 49 of the nut 48. Those skilled in the art will recognize that the classification of the aforementioned threaded regions may vary from that shown and described.

A chamfered portion 84 is defined on the mixing port 70 of the mixing device 26. In assembly, the nut 48 of the conduit assembly 28 is threaded onto the threaded region 82 of the mixing device 26 until the flared portion 47 of the conduit 43 is positioned in sealing contact with the chamfered portion 84 of the mixing device 26. Sealing contact between the flared portion 47 and chamfered portion 84 limits leakage of fluid at that interface. The angle of the chamfered portion 84 corresponds to the angle of the flared portion 47 of the conduit 43 (typically 45° or 37°).

A rotatable knob 44 is provided on the water tempering device 16 for setting the tempered water temperature delivered through the outlet port 42 of the mixing device 26. The functionality of the knob 44 is best described with reference to FIGS. 5D-5H.

FIG. 5D depicts a partial exploded perspective view of a portion of the mixing device 26, according to aspects of this invention. In FIG. 5D, the knob 44 is mounted to a stud 92, such that rotation of knob 44 induces rotation of stud 92. Specifically, a fastener 94 is mounted through a hole 95 of the knob 44 and threadedly engaged with a threaded hole 93 of the stud 92. The threaded hole 93 and the fastener 94 may optionally include left-hand threads to limit the fastener 94 from backing out of the hole 93 upon rotation of knob 44 in a counter-clockwise direction. The knob 44 optionally includes a gripping surface 96 that is provided for gripping the knob 44. The gripping surface 96 may be a knurled surface, scalloped surface, or any other style gripping surface.

The knob 44 is rotatable for setting the tempered water temperature delivered through the outlet port 42 of the mixing device 26. More specifically, the knob 44 is connected to the stud 92, and the stud 92 is a component of the thermostatic mixing valve 100. The stud 92 is capable of rotation with respect to the hexagon-shaped body of the thermostatic mixing valve 100 illustrated in FIG. 5E, while the hexagon-shaped body remains fixed in place. Although not shown, a thermostatic valve is positioned on the opposing end of the stud 92 for controlling the flow of cold water through the mixing port 70 (see FIG. 5A). It follows that rotation of the stud 92 (via knob 44) adjusts the position of the thermostatic valve (not shown), which controls the volume of cold water permitted to flow through the mixing port 70. The tempered water setting may be set by the installer of the water heater or the end user.

The mixing device 26 includes a locking ring 90 for either permitting or prohibiting rotation of the knob 44. In a locked configuration, as shown in FIGS. 5E and 5F, the locking ring 90 prohibits rotation of knob 44, whereas in an adjustable configuration, as shown in FIGS. 5G and 5H, the knob 44 is free to rotate with respect to the locking ring 90 in a limited range.

FIGS. 5E and 5G depicts a cross-sectional view of the locking ring 90 and the adjusting knob 44 taken along the lines 5E-5E of FIG. 5C. In FIG. 5E the knob 44 is positioned in a locked configuration, whereas the knob 44 is positioned in an adjustable configuration in FIG. 5G. FIGS. 5F and 5H depict detailed views of the locking ring and the adjusting knob illustrated in FIGS. 5E and 5G, respectively.

The locking ring 90 is provided on the mixing device 26 to either permit or prohibit rotation of the knob 44. The locking ring 90 includes interior gear teeth 102 for mating with the six edges 104 of the thermostatic mixing device 100 to prevent rotation of locking ring 90. The locking ring 90 is generally incapable of rotation once it is mated with the edges 104 of the mixing device 100.

Two detents 106 are disposed on the interior surface of the knob 44. The gap “G” disposed between the detents 106 shown in FIG. 5F is sized to accommodate the tab 108 provided on the locking ring 90. In the locked configuration shown in FIGS. 5E and 5F, the knob 44 is positioned over top of the locking ring 90 and the detents 106 are positioned on either side of the tab 108 of the locking ring 90. The tab 108 prevents rotation of the detents 106 (and knob 44). As discussed in greater detail later, the installer or end user sets the tempered water temperature to any desired level, positions the knob 44 to a locked position by positioning the detents over the tab 108, and engages the fastener 94 with the threaded hole 93 through the hole 95 of the knob 44. Once the fastener 94 is secured, the knob 44 is set to the locked configuration and can not be inadvertently adjusted.

In the adjustable configuration shown in FIGS. 5G and 5H, the detents 106 are positioned adjacent to the tab 108 of the locking ring 90, thereby permitting limited rotation of the detents 106 relative to the tab 108 along a limited range. According to one aspect of the invention, the knob 44 is capable of 350 degrees of rotation in a counterclockwise or clockwise direction in the adjustable configuration. It should be understood that the detents 106 can not rotate past the tab 108 in the adjustable configuration.

The end user or installer can change the configuration of the mixing device 26 from a locked to an adjustable configuration, and vice versa, by first removing the fastener 94 and the knob 44. The knob 44 is then repositioned over the locking ring 90 and the detents 106 of the knob 44 are then repositioned with respect to the tab 108 of the locking ring 90 to either a locked or an adjustable configuration.

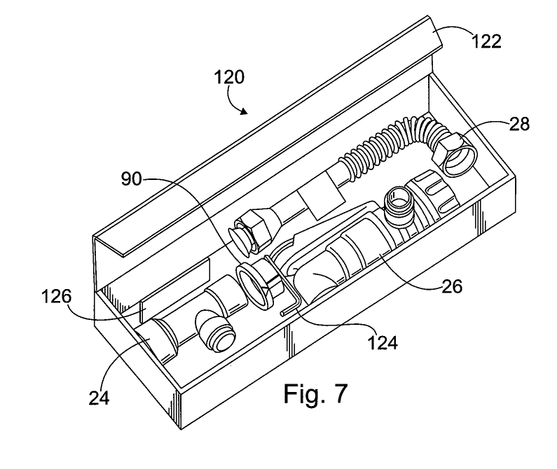

FIGS. 6A-6C depict front elevation, bottom plan and top plan views, respectively, of the locking ring 90. The locking ring 90 includes a hollow cylindrical body defining two axially aligned cylindrical portions 111 and 113. The diameter of the cylindrical portion 113 is greater than the diameter of the cylindrical portion 111. The gear teeth 102 are disposed on the interior surface of the cylindrical portion 111. The tab 108 is disposed on the exterior surface of the cylindrical portion 111.

The cylindrical portion 113 includes a base surface 112 for bearing against the body 76 of the mixing device 26, as shown in FIG. 5D. An arrow 110 is printed, applied, or formed on the exterior surface of the cylindrical portion 113, as shown in FIG. 6A. The arrow 110 is radially aligned with the tab 108. The arrow 110 is provided to indicate the position of the tab 108.

Referring now to FIGS. 1A-5H, the steps for assembling the water tempering device 16 onto a water heater 10, according to one exemplary use of the invention, are described hereinafter. It should be understood that the assembly procedure described hereinafter are not limited to any particular step, or any particular order or sequence of steps, and may vary from that shown and described. In the assembly procedure, it is assumed that the components of the water tempering device 16 are disassembled and provided in a kit (see FIG. 7A, for example), according to aspects of the invention.

The installer (or end user) first applies pipe thread sealant to the inlet and outlet ports 20 and 22 of the water heater 10 in an effort to minimize water leakage at the interface between the ports 20 and 22 and the device 16.

The fitting 24 is then installed onto the water heater 10 by fastening the interior threads 60 of the fitting 24 onto the threaded region of the inlet port 20 of the water heater 10. The fitting 24 is fastened onto the inlet port 20 until it is sufficiently seated and the mixing port 70 of the fitting 24 faces the front end of the water heater 10 (see FIG. 1A).

The conduit assembly 28 is then installed onto the fitting 24. First, the nut 45 is slid backwards to expose the flared portion 46 of the conduit 43. The flared portion 46 is then aligned with the chamfered portion 64 of the fitting 24. The nut 45 is slid in the forward direction to engage the interior threads 49 of the nut 45 with the threaded region 62 of the fitting 24. The nut 45 is gradually tightened, compressing the flared portion 46 of the tubing 43 against the chamfered portion 64 until the nut 45 is firmly seated in place. A fluid tight seal is obtained by mating the two beveled metallic surfaces (i.e., chamfered portion 64 and flared portion 46). The purpose of the nut 45 is to draw these two beveled surfaces together into sealing contact.

The mixing device 26 is then installed onto the water heater 10 by fastening the interior threads 78 of the mixing device 26 onto the threaded region of the outlet port 22 of the water heater 10. The mixing device 26 is fastened onto the outlet port 22 until it is sufficiently seated and the knob 44 faces the front end of the water heater 10 (see FIG. 1A).

The flexible portion 39 of the conduit assembly 28 is then gently bent to attach the conduit assembly 28 to the mixing device 26. First, the nut 48 is slid backwards to expose the flared portion 47 of the conduit 43. The flared portion 47 is then aligned with the chamfered portion 84 of the mixing device 26. The nut 48 is slid in the forward direction to engage the interior threads of the nut 48 with the threaded region 82 of the mixing device 26. The interior threads of the nut 48 are rotated onto the threaded region 82 of the mixing device 26 until the nut 48 is firmly seated.

The female threaded end of the cold water supply line 12 is threaded onto the threaded portion 58 of the fitting 24. Similarly, the female threaded end of the hot water supply line 14 is threaded onto the threaded portion 80 of the mixing device 26.

Assuming that the locking ring 90 is not pre-assembled to the mixing device 26, the installer or end user may rotate the knob 44 to set the tempered water temperature. Depending upon the end user requirements, the installer (or end user) may rotate the knob 44 in a counter-clockwise direction to increase the tempered water temperature. Conversely, the installer may rotate the knob 44 in a clockwise direction to decrease the tempered water temperature.

Once the desired tempered water temperature is reached, the installer may optionally mount the locking ring 90 to the mixing device 26, to set the knob 44 to either an adjustable configuration or a locked configuration.

More specifically, to set the knob 44 to a locked configuration, the fastener 94 and the knob 44 are temporarily removed from the mixing device 26. The locking device 90 is then installed over the mixing device 100 such that the arrow 110 of the locking device 90 is oriented as shown in FIG. 5D. The knob 44 is then repositioned such that the detents 106 of the knob 44 are positioned on either side of the tab 108 of the locking device 90 (as shown in FIG. 5F). The fastener 94 is then reinserted through the hole 95 of the knob 44 and threaded into the threaded hole 93 of the stud 92. The tab 108 prohibits rotation of the detents 106, such that the knob 44 can not be inadvertently rotated. The water heater 10 and the water tempering device 16 are then ready for use.

Alternatively, to set the knob 44 to an adjustable configuration, the fastener 94 and the knob 44 are temporarily removed from the mixing device 26. The locking device 90 is then installed over the mixing device 100 such that the arrow 110 of the locking device 90 is oriented as shown in FIG. 5D. The knob 44 is then repositioned such that the detents 106 of the knob 44 are positioned adjacent the tab 108 of the locking device 90 (as shown in FIG. 5H). The fastener 94 is then reinserted through the hole 95 of the knob 44 and threaded into the threaded hole 93 of the stud 92. In an adjustable configuration, the knob 44 may be rotated in either direction until the detents 106 of the knob 44 bear on the tab 108 of the locking ring 90 indicating that the maximum or' minimum tempered water temperature has been reached. The water heater 10 and the water tempering device 16 are then ready for use.

It should be understood from the foregoing description that the installation of the water tempering device 16 onto the water heater 10 does not require any, soldering, welding or pipe cutting operations. Additionally, no special tools are required for installing the water tempering device 16 to a water heater (either new or pre-existing) and water supply lines.

FIG. 7 depicts a top perspective schematic view of a kit 120 including the disassembled components of the water tempering device 16 (including the fitting 24, conduit assembly 28, locking ring 90 and the mixing device 26) placed within a packaging box 122 according to aspects of this invention. An Allen wrench 124 is optionally provided with the kit 120 for fastening the fastener 94 of the mixing device 26. An instruction manual 126 may also be provided with the kit 120. The instruction manual 126 contains instructions for assembling the water tempering device 16 onto a water heater. The kit 120 may be provided and packaged along with a new water heater. Alternatively, the kit 120 may be packaged and sold separately for retrofitting a water tempering device 16 to an existing water heater.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed:

1. A method of improving hot water supply performance of a water heater having a water storage tank, a cold water inlet port for receiving cold water from a cold water supply line, and a hot water outlet port for delivering hot water to a hot water supply line, said method comprising the steps of:
coupling an outlet port of a water tempering device to the cold water inlet port of the water heater for receiving cold water from the cold water supply line,
coupling an inlet port of the water tempering device to the hot water outlet port of the water heater for receiving hot water from the water storage tank, and
positioning a conduit of the water tempering device between the inlet port and the outlet port of the water tempering device for diverting a portion of the cold water received from the cold water supply line into the conduit,
wherein the water tempering device is configured to selectively mix the diverted cold water with the hot water received from the water storage tank and to deliver the mixed water into the hot water supply line.

2. The method of claim 1, wherein the step of coupling the outlet port of the water tempering device further comprises threadedly coupling the outlet port of the water tempering device to the cold water inlet port of the water heater.

3. The method of claim 1, wherein the step of coupling the inlet port of the water tempering device further comprises threadedly coupling the inlet port of the water tempering device to the hot water outlet port of the water heater.

4. The method of claim 1, wherein the step of coupling the outlet port of the water tempering device comprises coupling the outlet port of the water tempering device to a cold water inlet port extending upwardly from a top of the water heater.

5. The method of claim 1, wherein the step of coupling the inlet port of the water tempering device comprises coupling the inlet port of the water tempering device to a hot water outlet port extending upwardly from a top of the water heater.

6. The method of claim 1, wherein the step of coupling the outlet port of the water tempering device to the cold water inlet port of the water heater comprises threadedly coupling an outlet port of a fitting of the water tempering device to the cold water inlet port of the water heater.

7. The method of claim 6 further comprising the step of coupling an inlet port of the fitting of the water tempering device to the cold water supply line.

8. The method of claim 6, wherein the positioning step further comprises coupling a bypass port of the fitting of the water tempering device to an inlet port of the conduit of the water tempering device.

9. The method of claim 8, wherein the step of coupling an inlet port of the water tempering device to the hot water outlet port of the water heater comprises coupling an inlet port of a mixing device of the water tempering device to the hot water outlet port of the water heater.

10. The method of claim 9, wherein the positioning step further comprises bending at least a portion of the conduit to align an outlet port of the conduit of the water tempering device with a mixing port of the mixing device of the water tempering device.

11. The method of claim 9 further comprising the step of coupling an outlet port of the mixing device of the water tempering device to the hot water supply line.

12. A method of improving hot water supply performance of a water heater having a water storage tank, a cold water inlet port for receiving cold water from a cold water supply line, and a hot water outlet port for delivering hot water to a hot water supply line, said method comprising the steps of:
coupling a fitting of a water tempering device between the cold water inlet port of the water heater and the cold water supply line,
coupling a mixing device of the water tempering device between the hot water outlet port of the water heater and the hot water supply line,
coupling an end of a conduit of the water tempering device to either a bypass port of the fitting or a mixing port of the mixing device,
bending the conduit to align an opposing end of the conduit with the other of the bypass port of the fitting and the mixing port of the mixing device, and
coupling the opposing end of the conduit with the other of the bypass port of the fitting and the mixing port of the mixing device for diverting a portion of the cold water delivered from the cold water supply line through the conduit and into the mixing device,
wherein the water tempering device is configured to selectively mix the diverted cold water with the hot water received from the water storage tank and to deliver the mixed water into the hot water supply line.

13. The method of claim 12 further comprising the step of coupling an inlet port of the fitting of the water tempering device to the cold water supply line.

14. The method of claim 12 further comprising the step of coupling an outlet port of the mixing device of the water tempering device to the hot water supply line.

15. The method of claim 12, wherein the bending step comprises aligning an opposing end of the conduit with the other of the bypass port of the fitting and the mixing port of the mixing device such that the ends of the conduit are oriented along respective axes that are not parallel to one another.

16. The method of claim 12, wherein the fitting and the conduit are configured to direct all of the cold water received from the cold water supply line to the mixing port of the mixing device or the cold water inlet port of the water heater.

17. A method of improving hot water supply performance of a water heater having a water storage tank, a cold water inlet port for receiving cold water from a cold water supply line, and a hot water outlet port for delivering hot water to a hot water supply line, said method comprising the steps of:
coupling an outlet port of a fitting of a water tempering device to the cold water inlet port of the water heater,
coupling an inlet port of a mixing device of the water tempering device to the hot water outlet port of the water heater, and
coupling a conduit of the water tempering device between a bypass port of the fitting and a mixing port of the mixing device for diverting a portion of the cold water delivered from the cold water supply line through the conduit and into the mixing device, wherein the fitting and the conduit are configured to direct all cold water received from the cold water supply line to the mixing port of the mixing device or the cold water inlet port of the water heater,
wherein the water tempering device is configured to selectively mix the diverted cold water with the hot water received from the water storage tank and to deliver the mixed water into the hot water supply line.

18. The method of claim 17 further comprising the step of coupling an inlet port of the fitting of the water tempering device to the cold water supply line.

19. The method of claim 17 further comprising the step of coupling an outlet port of the mixing device of the water tempering device to the hot water supply line.
